(19) United States
(12) Patent Application Publication
(10) Pub. No.: US 2023/0259755 A1
(43) Pub. Date: Aug. 17, 2023

(54) EDGE-BASED FORECASTING OF ENVIRONMENTAL CONDITIONS

(71) Applicant: INTERNATIONAL BUSINESS MACHINES CORPORATION, Armonk, NY (US)

(72) Inventors: Fearghal O'DONNCHA, Aran Islands (IE); Amadou BA, Navan (IE); Albert AKHRIEV, Dublin (IE); Fabio LORENZI, Tyrrelstown (IE)

(73) Assignee: INTERNATIONAL BUSINESS MACHINES CORPORATION, Armonk, NY (US)

(21) Appl. No.: 17/650,798

(22) Filed: Feb. 11, 2022

(51) Int. Cl. G06N 3/08; H04L 67/12; G16Y 20/10; G16Y 40/10; G16Y 40/20

(52) U.S. Cl. CPC G06N 3/08; H04L 67/12; G16Y 20/10; G16Y 40/10; G16Y 40/20

(57) ABSTRACT

Embodiments for providing enhanced edge-based forecasting in a computing environment by a processor. Data from received from one or more data sources may be incorporated into a graph neural network. A forecast of one or more future conditions may be generated based the graph neural network using one or more forecasting models.

### BACKGROUND

The present invention relates in general to computing systems, and more particularly, to various embodiments for providing enhanced edge-based forecasting of environmental conditions in a computing environment using a computing processor.

### SUMMARY

According to an embodiment of the present invention, a method for providing enhanced edge-based forecasting of environmental conditions in a computing environment, by one or more processors, is depicted. Data received from one or more data sources may be incorporated into a graph neural network. A forecast of one or more future conditions may be generated by the graph neural network using one or more forecasting models.

An embodiment includes a computer usable program product. The computer usable program product includes a computer-readable storage device, and program instructions stored on the storage device.

An embodiment includes a computer system. The computer system includes a processor, a computer-readable memory, and a computer-readable storage device, and program instructions stored on the storage device for execution by the processor via the memory.

Thus, in addition to the foregoing exemplary method embodiments, other exemplary system and computer product embodiments are provided.

### BRIEF DESCRIPTION OF THE DRAWINGS

FIG. 1 is a block diagram depicting an exemplary cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 is an additional block diagram depicting an exemplary functional relationship between various aspects of the present invention.

FIG. 5 is a flowchart diagram depicting an exemplary method for providing enhanced edge-based forecasting of environmental conditions in a computing environment according to an embodiment of the present invention.

FIG. 6 is a flowchart diagram depicting an additional exemplary method for providing enhanced edge-based forecasting of environmental conditions in a computing environment according to an embodiment of the present invention.

FIG. 7 is a flowchart diagram depicting an additional exemplary method for providing enhanced edge-based forecasting of environmental conditions in a computing environment, by a processor, in which aspects of the present invention may be realized.

FIG. 8 is a flowchart diagram depicting an additional exemplary method for providing enhanced edge-based forecasting of environmental conditions in a computing environment according to an embodiment of the present invention.

### DETAILED DESCRIPTION OF THE DRAWINGS

Over the last decade, data analytics has become an important trend in many industries. For example, aquaculture operates in harsh ocean environments and are exposed to adverse events that can cause significant harm to sea life. An aquaculture farm may include various types of fish cages, and there is a complex and uncertain relationship between condition within those cages. Generally, a sensor (or sensors) sample conditions within all or a subset of the cages. Some approaches exist that aims to make forecast based on conditions observed by a single sensor, but there are currently no sensors that exploit the information collected at multiple neighboring sensors to improve forecasting of environmental conditions and assist operational response to potential adverse conditions such as, for example, low oxygen levels, extreme temperature, or excess nutrient concentrations.

As such, a need exists for providing enhanced edge-based forecasting of environmental conditions. In one aspect, data received from one or more data sources may be incorporated into a graph neural network. A forecast of one or more future conditions may be generated based the graph neural network using one or more forecasting models.

In other implementations, the present invention provides for an edge-based monitoring and forecasting system that measures current conditions and provides short term forecasts based on edge-modeling system (e.g., a machine learning based surrogate of ocean waves or temperature). In some implementations, the present invention may be a recording system that sends collected results of monitoring one or more sensors to one or more reading devices in a plurality of situations including performance degradation. In some implementations, the present invention provides analytics and monitoring capabilities integrated into one or more sensors or central hub. The present invention provides collaborative monitoring and exploits the characteristics of data at a given station, k, and at time t to monitor the same data at a station, k+1, and at time t or t+h, where h being the horizon of forecasting in the temporal domain. In some implementations, the present invention may use a graph convolutional network (“GCNN”) and take advantage of the structure of a graph to conduct learning and monitoring. In this way, the present invention circumvents thee challenges of communication both under water and to the internet.

In other implementations, the present invention provides for edge (or fog) based forecasting of environmental conditions to inform aquaculture operations using one or more processors, where the edge (or fog) based forecasting computing system is a self-contained edge- or fog-based system to circumvent connectivity issues. The present invention provides computationally lightweight edge forecasting models that provides instant/rapid forecasts of one or more environmental conditions (e.g., ocean environmental conditions). A decision is provided on whether the projected future conditions require modification to farm operations. A collaborative forecasting operation is executed that learns information from multiple (and/or correlated) sensors in a collaborative data sharing operation to enhance prediction skill.

In some implementations, one or more sensors or a sensor network monitors the environmental conditions. A machine learning model may be trained on historical data or training may be updated with real-time data. The edge-based forecasting of environmental conditions may predict anomalous or harmful conditions, while providing accurate forecasts of environmental conditions that integrates observation with forecast. A collaborative forecasting operation integrates information from neighboring sensors to improve anomaly or risk detection.

In other implementations, a machine learning model may include a knowledge domain that may be used and may include an ontology of concepts representing a domain of knowledge. A thesaurus or ontology may be used as the domain knowledge and may also be used to associate various characteristics, parameters, values, attributes, symptoms, behaviors, sensitivities, parameters, user profiles, computing device profiles, environmental, topology, geography and climate profiles, relationships and/or computing devices. In one aspect, the term “domain” is a term intended to have its ordinary meaning. In addition, the term “domain” may include an area of expertise for a system or a collection of materials, information, content and/or other resources related to a particular subject or subjects.

The term ontology is also a term intended to have its ordinary meaning. In one aspect, the term ontology in its broadest sense may include anything that can be modeled as ontology, including but not limited to, taxonomies, thesauri, vocabularies, and the like. For example, an ontology may include information or content relevant to a domain of interest or content of a particular class or concept. The ontology can be continuously updated with the information synchronized with the sources, adding information from the sources to the ontology as models, attributes of models, or associations between models within the ontology.

It should be noted as described herein, the term “intelligent” (or “cognition”) may be relating to, being, or involving conscious intellectual activity such as, for example, thinking, reasoning, or remembering, that may be performed using a machine learning. In an additional aspect, intelligent or “intelligence” may be the mental process of knowing, including aspects such as awareness, perception, reasoning and judgment. A machine learning system may use artificial reasoning to interpret data from one or more data sources (e.g., sensor-based devices or other computing systems) and learn topics, concepts, judgment reasoning knowledge, and/or processes that may be determined and/or derived by machine learning.

In general, as used herein, “optimize” (or “enhanced”) may refer to and/or defined as “maximize,” “minimize,” “most likely,” “best,” or attain one or more specific targets, objectives, goals, or intentions. Optimize may also refer to maximizing a benefit to a user (e.g., maximize a trained machine learning pipeline/model benefit). Optimize may also refer to making the most effective or functional use of a situation, opportunity, or resource.

Additionally, optimizing need not refer to a best solution or result but may refer to a solution or result that “is good enough” or “most likely” for a particular application, for example. In some implementations, an objective is to suggest a “best” combination of preprocessing operations (“preprocessors”) and/or machine learning models/machine learning pipelines, but there may be a variety of factors that may result in alternate suggestion of a combination of preprocessing operations (“preprocessors”) and/or machine learning models yielding better results. Herein, the term “optimize” may refer to such results based on minima (or maxima, depending on what parameters are considered in the optimization problem). In an additional aspect, the terms “optimize” and/or “optimizing” may refer to an operation performed in order to achieve an improved result such as reduced execution costs or increased resource utilization, whether or not the optimum result is actually achieved. Similarly, the term “optimize” may refer to a component for performing such an improvement operation, and the term “optimized” may be used to describe the result of such an improvement operation.

It is understood in advance that although this disclosure includes a detailed description on cloud computing, implementation of the teachings recited herein are not limited to a cloud-computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

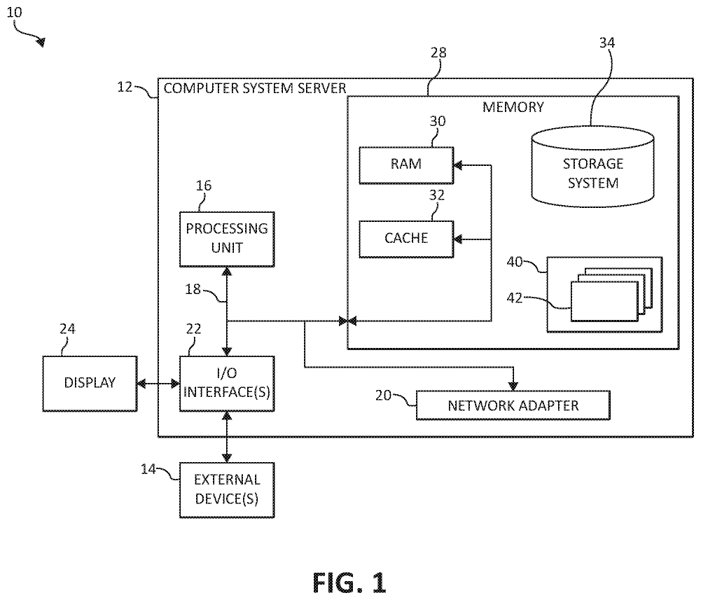

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 12.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

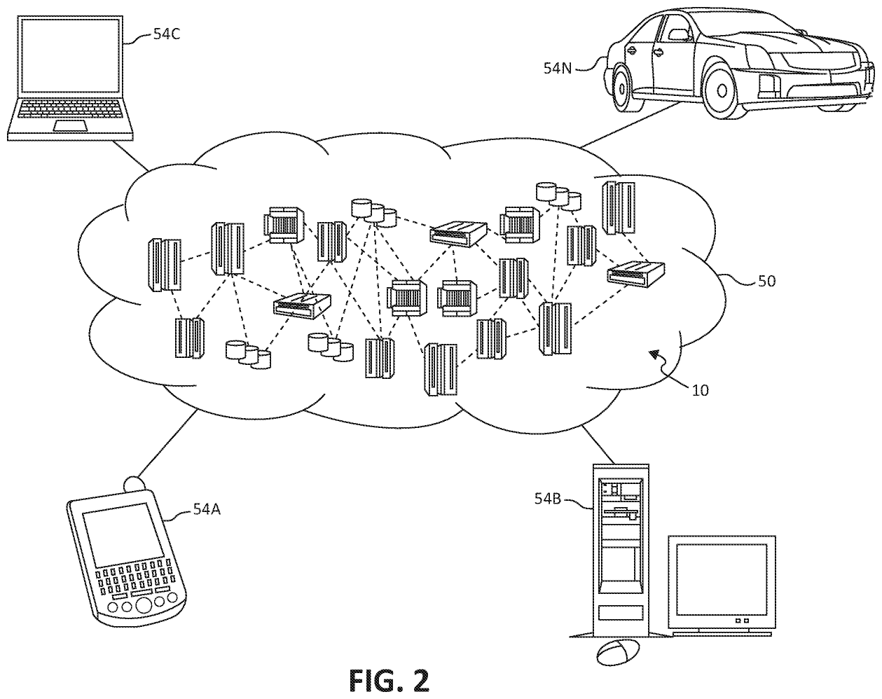

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

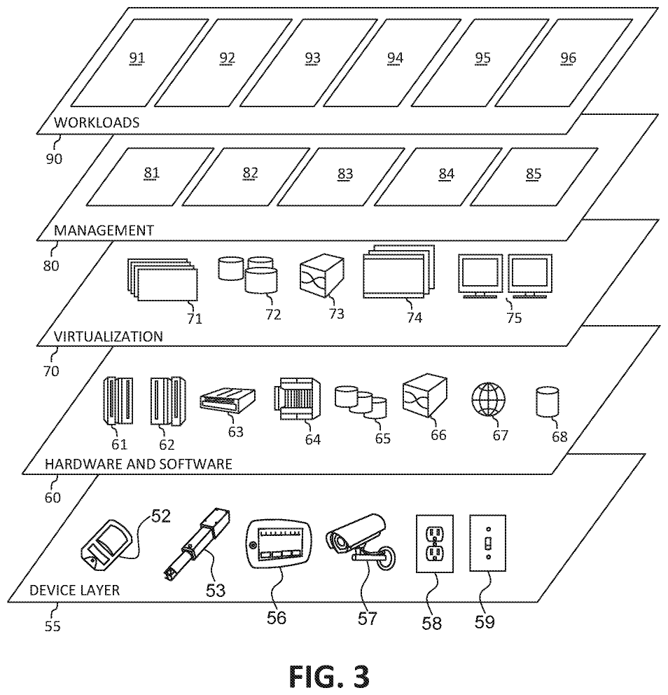

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for providing enhanced edge-based forecasting of environmental conditions. In addition, workloads and functions 96 for providing enhanced edge-based forecasting of environmental conditions may include such operations as data analytics, data analysis, and as will be further described, notification functionality. One of ordinary skill in the art will appreciate that the workloads and functions 96 for providing enhanced edge-based forecasting of environmental conditions may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

As previously mentioned, the present invention provides a novel solution for providing enhanced edge-based forecasting of environmental conditions in a computing environment, by one or more processors. Data from received from one or more data sources may be incorporated into a graph neural network. A forecast of one or more future conditions may be generated based the graph neural network using one or more forecasting models.

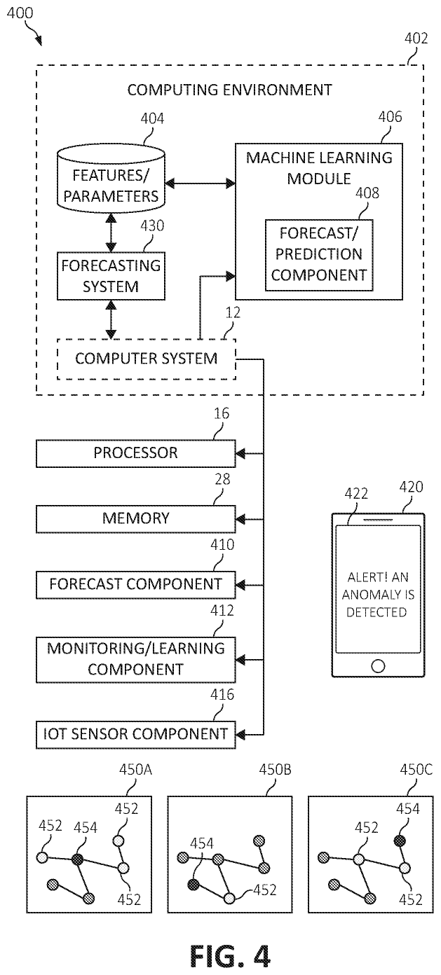

Turning now to FIG. 4, is a block diagrams depicting exemplary functional component 400 according to various mechanisms of the illustrated embodiments is shown. In one aspect, one or more of the components, modules, services, applications, and/or functions described in FIGS. 1-3 may be used in FIG. 4. Repetitive description of like elements employed in other embodiments described herein is omitted for sake of brevity.

FIG. 4 illustrates providing an enhanced edge-based forecasting of environmental conditions in a computing environment, such as a computing environment 402, according to an example of the present technology. As will be seen, many of the functional blocks may also be considered “modules” or “components” of functionality, in the same descriptive sense as has been previously described in FIGS. 1-3. With the foregoing in mind, the module/component blocks 400 may also be incorporated into various hardware and software components of a system for providing an enhanced edge-based forecasting of environmental conditions in accordance with the present invention. Many of the functional blocks 400 may execute as background processes on various components, either in distributed computing components, or on the user device, or elsewhere. Computer system/server 12 is again shown, incorporating processing unit 16 and memory 28 to perform various computational, data processing and other functionality in accordance with various aspects of the present invention.

The system 400 may include the computing environment 402 (e.g., included in a heat exchange system/unit), a forecasting system 430, and a device 420, such as a desktop computer, laptop computer, tablet, smartphone, and/or another electronic device that may have one or more processors and memory. The device 420, the forecasting system 430, and the computing environment 402 may each be associated with and/or in communication with each other, by one or more communication methods, such as a computing network. In one example, the device 420 and/or the forecasting system 430 may be controlled by an owner, customer, or technician/administrator associated with the computing environment 402. In another example, the device 420 and/or the forecasting system 430 may be completely independent from the owner, customer, or technician/administrator of the computing environment 402.

In one aspect, the computing environment 402 may provide virtualized computing services (i.e., virtualized computing, virtualized storage, virtualized networking, etc.) to devices 420. More specifically, the computing environment 402 may provide virtualized computing, virtualized storage, virtualized networking and other virtualized services that are executing on a hardware substrate.

As depicted in FIG. 4, the computing environment 402 may include a machine learning module 406, a features and/or parameters 404 (e.g., “parameters” of a predictive model) that is associated with a machine learning module 406, and the forecasting system 430. The features and/or parameters database 404 may also include energy usage profiles, sensor profiles (e.g., sensor characteristics or parameters) for each forecasting system 430 and/or sensor devices associated with an IoT sensor component 416. It should be noted that one or more IoT sensor devices may be represented as the IoT sensor component 416 may be coupled to the forecasting system 430. In one aspect, the IoT sensor component 416 may be a smart sensor that may record environmental conditions (e.g., conditions within an ocean). The IoT sensor component 416 may record the environmental conditions (e.g., temperature, light, waves, air flow, etc.) in selected time intervals and communicate that information at various selected periods of time. In an additional aspect, the IoT sensor component 416 may be associated with one or more smart sensor for collecting, recording, and measuring energy consumption.

The features and/or parameters 404 may be a combination of features, tuning parameters, environmental characteristics (e.g., characteristics of an ocean and topology, etc.), energy consumption data, temperature data, historical data, tested and validated data, or other specified/defined data for testing, monitoring, validating, detecting, learning, analyzing and/or calculating various conditions or diagnostics relating to cognitively detecting anomalies in the forecasting system 430. That is, different combinations of parameters may be selected and applied to the input data for learning or training one or more machine learning models of the machine learning module 406. The features and/or parameters 404 may define one or more settings of the IoT sensors (e.g., smart meters) associated with the IoT sensor component 416 to enable the collecting, recording, and measuring of environmental conditions. The one or more the IoT sensors (e.g., smart sensors) associated with the IoT sensor component 416 may be coupled to the forecasting system 430 at one or more defined distances from alternative IoT sensors as depicted in sensor networks 450A-C.

The computing environment 402 may also include a computer system 12, as depicted in FIG. 1. The computer system 12 may also include the forecast component 410, a monitoring/learning component 412, and an IoT sensor component 416 each associated with the machine learning module for training and learning one or more machine learning models and also for applying multiple combinations of features, tuning parameters, environmental characteristics, normalized/standardized environmental readings/values, previously estimated environmental readings/values, temperature data, or a combination thereof to the machine learning model for providing enhanced edge-based forecasting of environmental conditions.

The computer system 12 may also include a forecast component 410 and a monitoring/learning component 412. In some implementations, the forecast component 410 and the monitoring/learning component 412 may incorporate data from received from one or more data sources into a graph neural network and generate a forecast of one or more future conditions based the graph neural network using one or more forecasting models.

In some implementations, the forecast component 410 and the monitoring/learning component 412 may collect the data from one or more sensors and all neighboring sensors connected to the one or more sensors. In some implementations, the forecast component 410 and the monitoring/learning component 412 may monitor physical and environmental conditions based on measurements received from one or more sensors and all neighboring sensors connected to the one or more sensors.

In some implementations, the forecast component 410 and the monitoring/learning component 412 may learn physical and environmental conditions based on measurements received from one or more sensors and all neighboring sensors connected to the one or more sensors using the one or more forecasting models. The forecast component 410 and the monitoring/learning component 412 may classify the forecast as an anomalous forecast.

In other implementations, the forecast component 410 and the monitoring/learning component 412 may generate a model representation of physical and environmental conditions using the edge-based prediction model. In some implementations, the forecast component 410 and the monitoring/learning component 412 may determine one or more anomalies from current physical and environmental conditions based on the model representation of physical and environmental conditions.

Also, the monitoring/learning component 412 may process data (cleaning, curation, etc.), determine a cluster of stations (adjacency matrix) to be considered for learning, and update one or more parameters of a machine learning model of a classification operation. It should be noted that “stations” can refer to the individual IoT sensors deployed in a farm and “adjaceny matrix” can refers to the graph connections between sensors. The adjacency matrix denotes whether each sensor is adjacent to every other sensor and quantifies the degree of adjaceny between sensors. The monitoring/learning component 412 may be distributed across all sensors and conducted independently by all sensors, or function as a single ‘hub’ device can manage and communicate to all sensors.

In other implementations, the forecast component 410 and the monitoring/learning component 412 may monitor each the sensor network 450A-C.

That is, the forecast component 410 and the monitoring/learning component 412 may, in association with the IoT sensor component 416, may enable one or more reading systems (IoT sensors or sensor network 450A-C) for capturing environmental conditions data. For example, sensor station 454 may be monitored by exploiting a strength of an adjacency matrix 452. The forecast component 410 and the monitoring/learning component 412 may reduce the time to detect an anomaly through the collaboration between the adjacent nodes (sensors at different locations in the sensor network 450A-C (e.g., an aquaculture farm) and implement an early corrective measures as a result of anomaly detection.

The forecast component 410 and the monitoring/learning component 412 may alert a user (e.g., via device 420) of the detected generated forecast of future environmental conditions based the graph neural network using one or more forecasting models. The device 420 may include a graphical user interface (GUI) 422 enabled to display on the device 420 one or more user interface controls for a user to interact with the GUI 422. For example, the GUI 422 may display the detected environmental condition anomalies to a user via an interactive graphical user interface (GUI). For example, the output to the device may be an alert that indicates or displays audibly and/or visually on the GUI 422 “ALERT! An anomaly is detected” (e.g., an anomaly of environmental conditions based the graph neural network using one or more forecasting models).

In other implementations, the forecast component 410, the forecast/prediction component 408, and the monitoring/learning component 412 may apply a lightweight collaborative forecasting operation to improve event detection in a target environment (e.g., aquaculture). The forecast component 410, the forecast/prediction component 408, and the monitoring/learning component 412 may adopts a graph neural network operation to allow information from neighboring sensors to be incorporated in a prediction model. The forecast component 410, the forecast/prediction component 408, and the monitoring/learning component 412 may rely on low compute power and low communication requirements in terms of bandwidth. The forecast component 410, the forecast/prediction component 408, and the monitoring/learning component 412 may use edge analytics at one or more stations level able to operate with embedded GCNN such as, for example, for scoring. The forecast component 410, the forecast/prediction component 408, and the monitoring/learning component 412 may use fog analytics to optimize machine learning model training with low-to-moderate communication bandwidth.

In one aspect, the machine learning module 406 may include a forecast/prediction component 408 for predicting edge-based forecasting of environmental conditions according to one or more energy consumption measurements, weather data, and one or more environmental characteristics, or a combination thereof. The machine learning module 406 may collect feedback information from the one or more IoT sensors associated with the IoT sensor component 416 to estimate one or more parameters of one or more prediction models for providing enhanced edge-based forecasting of environmental conditions. The machine learning module 406 may use the feedback information to provide enhanced edge-based forecasting of environmental conditions according to the prediction using the forecast/prediction component 408. The machine learning module 406 may be initialized using feedback information to learn behavior of the forecasting system 430 for environmental location, which may be associated with one or more sensors and/or the sensor networks 450A-C.

In one aspect, the machine learning operations of the machine learning module 406 as described herein, may be performed using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, backpropagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boo sting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting example of temporal difference learning may include Q-learning and learning automata. Specific details regarding any of the examples of supervised, unsupervised, temporal difference or other machine learning described in this paragraph are known and are beyond the scope of this disclosure. Also, when deploying one or more machine learning models, a computing device may be first tested in a controlled environment before being deployed in a public setting. Also even when deployed in a public environment (e.g., external to the controlled, testing environment), the computing devices may be monitored for compliance.

In one aspect, the computing system 12/computing environment 402 may perform one or more calculations according to mathematical operations or functions that may involve one or more mathematical operations (e.g., solving differential equations or partial differential equations analytically or computationally, using addition, subtraction, division, multiplication, standard deviations, means, averages, percentages, statistical modeling using statistical distributions, by finding minimums, maximums or similar thresholds for combined variables, etc.).

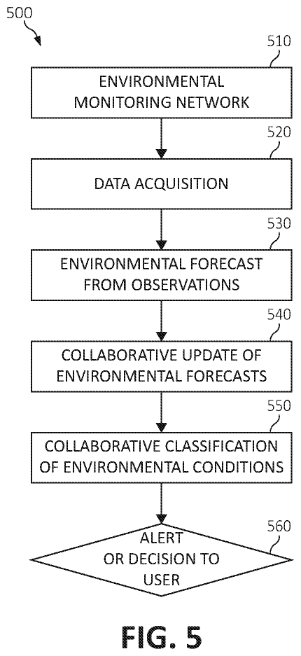

For further explanation, FIG. 5 is a flowchart diagram depicting an exemplary method for providing enhanced edge-based forecasting of environmental conditions in a computing environment according to an embodiment of the present invention. In some implementations, each of the devices, components, modules, operations, and/or functions described in FIGS. 1-4 also may apply or perform one or more operations or actions of FIG. 5. The functionality 500 may be implemented as a method executed as instructions on a machine, where the instructions are included on at least one computer readable medium or one non-transitory machine-readable storage medium.

As depicted in block 510, the computing system 12/computing environment 402 of FIGS. 1-4, provides an environmental monitoring network. In block 520, data may be acquired such as, for example, one or more IoT sensor devices records data on environmental conditions and curates based on IoT semantic information. The computing system 12/computing environment 402, using one or more sensors may records data, perform semantic integration, perform prediction station by station (e.g., a sensor network station), and detect deviations from ambient conditions of a targeted location.

In block 530, the computing system 12/computing environment 402 of FIGS. 1-4, provides an environmental forecast from one or more observations (from the data acquired from the IoT sensor devices). That is, the computing system 12 functions as an edge-based compute device to generates forecast from observations using a trained machine learning model.

In block 540, collaborated data may be received from one or more IoT sensor devices and neighboring sensor devices associated with or in communication with the one or more IoT sensor devices and the environmental forecast may be collaboratively updated. That is, the data from one or more sensors can be used to create the forecast. The forecasted data are classified as anomalous or non-anomalous using a trained classification module. Data from one or more sensors can be used to classify the data as anomalous. In block 560, a decision operation is executed to determine to alert or provide a decision that is sent to the user based on the result of the classification operation.

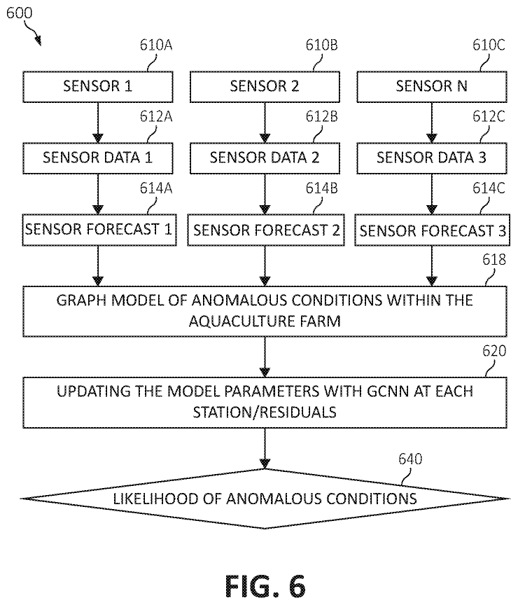

For further explanation, FIG. 6 is a flowchart diagram depicting an additional exemplary method for providing enhanced edge-based forecasting of environmental conditions in a computing environment according to an embodiment of the present invention. In some implementations, each of the devices, components, modules, operations, and/or functions described in FIGS. 1-5 also may apply or perform one or more operations or actions of FIG. 6. The functionality 600 may be implemented as a method executed as instructions on a machine, where the instructions are included on at least one computer readable medium or one non-transitory machine-readable storage medium.

As depicted, one or more sensors such as, for example, sensor 1 610A, sensor 2 610B, sensor N 610N may provide data such as, for example, sensor data 1 612A, sensor data 2 612B, sensor data 3 612C.

A forecast (e.g., an environmental forecast) may be generated such as, for example, sensor forecast 1 614A, sensor forecast 2 614B, sensor forecast 3 614C.

Using the sensor forecast 1 614A, sensor forecast 2 614B, sensor forecast 3 614C, a graph model may be generated of anomalous conditions within an environmental location such as, for example, an aquaculture farm, as in block 618. A determination operation is executed to determine a likelihood (e.g., a percentage, a value above or below a threshold, etc.) of anomalous conditions, as in block 640.

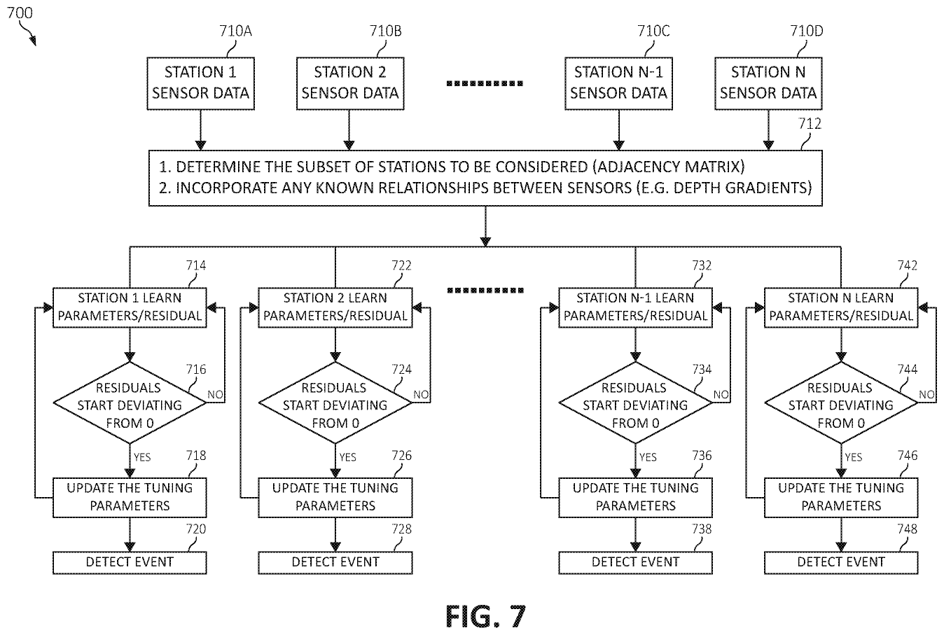

FIG. 7 is a flowchart diagram depicting an additional exemplary method for providing enhanced edge-based forecasting of environmental conditions in a computing environment, by a processor, in which aspects of the present invention may be realized. In some implementations, each of the devices, components, modules, operations, and/or functions described in FIGS. 1-6 also may apply or perform one or more operations or actions of FIG. 7. The functionality 700 may be implemented as a method executed as instructions on a machine, where the instructions are included on at least one computer readable medium or one non-transitory machine-readable storage medium.

As depicted, one or more stations 710A-D may each provided sensor data such as, for example, station 1 sensor data, station 2 sensor data, station sensor data N−1, and station N sensor data. In block 712, 1) a determination operation is executed to determine a subset of stations (e.g., stations 710A-D) to be considered (e.g., adjacency matrix), and 2) incorporated any known relationships between one or more sensors (e.g., depth gradients).

For each of the stations (e.g., stations 710A-D), the following similar operations are performed. In block 714, station 1 learns one or more parameters/residuals. The residuals are computed by subtracting the time averaged mean and the model parameters are updated when the residual deviate from zero indicating a change in the characteristics of the signal. When the characteristics change, the model parameters are updated to improve accuracy. In block 716, a determination operation is performed to determine if the residuals are starting to deviate from a zero value. If no, the functionality 700 returns to block 714. If yes, one or more tuning parameters are updated, as in block 718. In block 720, an event may be detected.

In block 722, station 2 learns one or more parameters/residuals. In block 724, a determination operation is performed to determine if the residuals are starting to deviate from a zero value. If no, the functionality 700 returns to block 722. If yes, one or more tuning parameters are updated, as in block 726. In block 728, an event may be detected. In some implementations, an event may be defined by the operational characteristics of the farm. An example is toxic algae concentrations for shellfish farms. Regulatory authorities enforce limits on the levels that may be present in farmed shellfish and values approaching these limits may be defined as an “event” by the farm operator.

In block 732, station N−1 learns one or more parameters/residuals. In block 734, a determination operation is performed to determine if the residuals are starting to deviate from a zero value. If no, the functionality 700 returns to block 732. If yes, one or more tuning parameters are updated, as in block 736. In block 738, an event may be detected.

In block 742, station N learns one or more parameters/residuals. In block 744, a determination operation is performed to determine if the residuals are starting to deviate from a zero value. If no, the functionality 700 returns to block 742. If yes, one or more tuning parameters are updated, as in block 746. In block 748, an event may be detected.

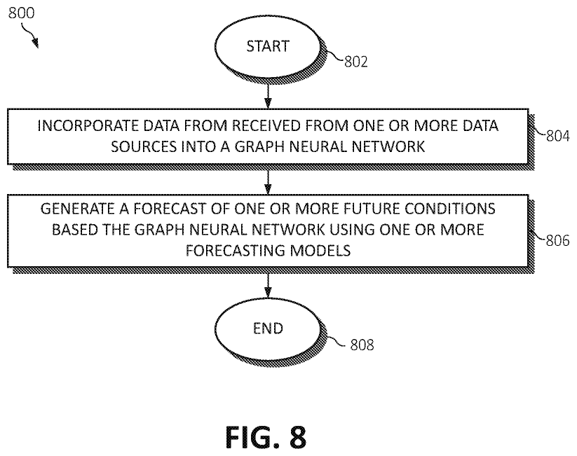

FIG. 8 is a flowchart diagram depicting an exemplary method for providing enhanced edge-based forecasting of environmental conditions in a computing environment. In one aspect, each of the devices, components, modules, operations, and/or functions described in FIGS. 1-7 also may apply or perform one or more operations or actions of FIG. 8. The functionality 800 may be implemented as a method executed as instructions on a machine, where the instructions are included on at least one computer readable medium or one non-transitory machine-readable storage medium. The functionality 800 may start in block 802.

Data from received from one or more data sources may be incorporated into a graph neural network, as in block 804. A forecast of one or more future conditions may be generated based the graph neural network using one or more forecasting models, as in block 806. In one aspect, the functionality 800 may end, as in block 808.

In one aspect, in conjunction with and/or as part of at least one block of FIG. 8, the operations of method 800 may include each of the following. The operations of method 800 may collect the data from one or more sensors and all neighboring sensors connected to the one or more sensors. The operations of method 800 may monitor physical and environmental conditions based on measurements received from one or more sensors and all neighboring sensors connected to the one or more sensors. The operations of method 800 may learn physical and environmental conditions based on measurements received from one or more sensors and all neighboring sensors connected to the one or more sensors using the one or more forecasting models.

The operations of method 800 may classify the forecast as an anomalous forecast. The operations of method 800 may generate a model representation of physical and environmental conditions using the edge-based prediction model and determine one or more anomalies from current physical and environmental conditions based on the model representation of physical and environmental conditions.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method, by a processor, for providing enhanced edge-based forecasting in a computing environment, comprising:
incorporating data from received from one or more data sources into a graph neural network; and
generating a forecast of one or more future conditions based the graph neural network using one or more forecasting models.

2. The method of claim 1, further including collecting the data from one or more sensors and all neighboring sensors connected to the one or more sensors.

3. The method of claim 1, further including monitoring physical and environmental conditions based on measurements received from one or more sensors and all neighboring sensors connected to the one or more sensors.

4. The method of claim 1, further including learning physical and environmental conditions based on measurements received from one or more sensors and all neighboring sensors connected to the one or more sensors using the one or more forecasting models.

5. The method of claim 1, further including classifying the forecast as an anomalous forecast.

6. The method of claim 1, further including generating a model representation of physical and environmental conditions using the edge-based prediction model.

7. The method of claim 6, further including determining one or more anomalies from current physical and environmental conditions based on the model representation of physical and environmental conditions.

8. A system for providing enhanced edge-based forecasting in a computing environment, comprising:
one or more computers with executable instructions that when executed cause the system to:
incorporate data from received from one or more data sources into a graph neural network; and
generate a forecast of one or more future conditions based the graph neural network using one or more forecasting models.

9. The system of claim 8, wherein the executable instructions that when executed cause the system to collect the data from one or more sensors and all neighboring sensors connected to the one or more sensors.

10. The system of claim 8, wherein the executable instructions that when executed cause the system to monitor physical and environmental conditions based on measurements received from one or more sensors and all neighboring sensors connected to the one or more sensors.

11. The system of claim 8, wherein the executable instructions that when executed cause the system to learn physical and environmental conditions based on measurements received from one or more sensors and all neighboring sensors connected to the one or more sensors using the one or more forecasting models.

12. The system of claim 8, wherein the executable instructions that when executed cause the system to classify the forecast as an anomalous forecast.

13. The system of claim 8, wherein the executable instructions that when executed cause the system to generate a model representation of physical and environmental conditions using the edge-based prediction model.

14. The system of claim 13, wherein the executable instructions that when executed cause the system to determine one or more anomalies from current physical and environmental conditions based on the model representation of physical and environmental conditions.

15. A computer program product for providing enhanced edge-based forecasting in a computing environment, the computer program product comprising:
one or more computer readable storage media, and program instructions collectively stored on the one or more computer readable storage media, the program instruction comprising:
program instructions to incorporate data from received from one or more data sources into a graph neural network; and
program instructions to generate a forecast of one or more future conditions based the graph neural network using one or more forecasting models.

16. The computer program product of claim 15, further including program instructions to collect the data from one or more sensors and all neighboring sensors connected to the one or more sensors.

17. The computer program product of claim 15, further including program instructions to monitor physical and environmental conditions based on measurements received from one or more sensors and all neighboring sensors connected to the one or more sensors.

18. The computer program product of claim 15, further including program instructions to learn physical and environmental conditions based on measurements received from one or more sensors and all neighboring sensors connected to the one or more sensors using the one or more forecasting models.

19. The computer program product of claim 15, further including program instructions to classify the forecast as an anomalous forecast.

20. The computer program product of claim 15, further including program instructions to:
generate a model representation of physical and environmental conditions using the edge-based prediction model; and
determine one or more anomalies from current physical and environmental conditions based on the model representation of physical and environmental conditions.
